(19) United States
(12) Patent Application Publication
(10) Pub. No.: US 2012/0200104 A1
(43) Pub. Date: Aug. 9, 2012

(54) TAILGATE GAP COVERING APPARATUS AND METHOD

(76) Inventor: Kurt E. Olson, Tacoma, WA (US)

(21) Appl. No.: 13/448,184

(22) Filed: Apr. 16, 2012

Related U.S. Application Data
(62) Division of application No. 12/571,719, filed on Oct. 1, 2009.

(51) Int. Cl. B62D 25/00

(52) U.S. Cl. 296/1.06

(57) ABSTRACT

A tailgate gap cover for covering a gap between two adjacent surfaces includes an elongated top member where the top member has a generally arcuate T-shaped cross-sectional profile and the top member includes left and right wing members, the left and right wing members each having a plurality of relief channels extending along an underside of each of the left and right wing members, where the plurality of relief channels provide added flexibility. An elongated concave relief central portion extends lengthwise along the center of the top member. An elongated insertion panel is affixed to a central bottom portion of the top member, where the elongated insertion panel extends downwardly substantially perpendicular from the top member.

### CROSS-REFERENCE TO RELATED APPLICATIONS

This application is a divisional application claiming priority of co-pending U.S. application Ser. No. 12/571,719, filed on Oct. 1, 2009, entitled “Tailgate Gap Covering Apparatus And Method,” which is incorporated herein by reference.

### TECHNICAL FIELD

The present invention relates to an elongated flexible seal or barrier for covering gaps in decking and the like in general, and, more particularly, to a barrier that covers gaps as between a pick-up truck tailgate and bed.

### BACKGROUND

Tailgate gap covers are needed for pickup trucks and the like transporting small or fine cargos such as gravel or sand. Some commercially available tailgate gap covers consist of flat strips that can be fastened with adhesive or tape when installed. Such commercially available gap covers have disadvantages, such as inadequate adhesive or functionality. Further, since they are permanently affixed, they cannot be used on more than one vehicle.

Various other apparatus and methods of covering a gap between tailgate members, decks or panels are available. For example, U.S. Pat. No. D 374,854, to Little et al., issued Oct. 22, 1996, entitled, “Tailgate Gap Cover” shows a “T” style gap cover with beveled edges. However, such designs have limited flexibility.

As a further example, U.S. Pat. No. 5,664,822, to Rosenfield, issued Sep. 9, 1997, entitled, “Tailgate Gap Cover,” discloses a tailgate gap cover for attachment to pickup trucks to cover the gap formed between the tailgate and the truck bed. Rosenfield's tailgate gap cover includes a plurality of adjacently disposed interconnected panels. A folding panel is foldable from an unfolded configuration when the tailgate is in the horizontal open position, to a folded configuration when the tail gate is pivoted from the horizontal open position to the vertical closed position.

As another example, U.S. Pat. No. 7,052,070, to Simonin, issued May 30, 2006, entitled, “Tailgate Gap Cover,” teaches a device for covering in the crack formed when a pickup or similar truck's tailgate is lowered from engagement with the truck bed. The device is rectilinear in cross sections, formed from a center section and two side sections, with the side sections having a bottom surface inwardly disposed cutout pattern at one end, and either a recess or insert on the interior end face for engagement with a corresponding insert or recess on the end faces of the center section. The front to back distance and the top to bottom distance are substantially equal to the dimensions of the crack where the device is intended to reside.

The present disclosure provides new and novel solutions to overcome deficiencies found in the aforesaid devices. Despite the teachings of the aforesaid patents there remains a need for covering a gap in a tailgate or marine deck using a more flexible apparatus which can be more easily inserted and removed. Further, there is a need in some applications for a gap cover having an anchoring feature for improved stability during use.

Other useful applications of the tailgate gap cover disclosed herein include uses in heavy duty commercial trucks. The tailgate gap cover may also double as a cushioning pad to allow moving around the tailgate area more comfortable for users.

### BRIEF SUMMARY OF THE DISCLOSURE

A tailgate gap cover for covering a gap between two adjacent surfaces includes an elongated top member where the top member has a generally arcuate T-shaped cross-sectional profile. An elongated concave relief central portion extends lengthwise along the center of the top member. An elongated insertion panel is affixed to a central bottom portion of the top member, where the elongated insertion panel extends downwardly substantially perpendicular from the top member.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows an isometric view of an example of a tailgate gap cover.

FIG. 2 schematically shows a cross-sectional view of an alternate example of a tailgate gap cover.

FIG. 3 schematically shows a cross-sectional view of another alternate example of a tailgate gap cover.

FIG. 4A schematically shows a cross-sectional view of a further alternate example of a flexible gap cover.

FIG. 4B schematically shows a cross-sectional view of the alternate example of a flexible gap cover of FIG. 4A in use as a marine deck gap cover.

FIG. 5 schematically shows a cross-sectional view of yet another alternate example of a tailgate gap cover.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments for a flexible elongated gap cover. Several features of methods and devices in accordance with example embodiments are set forth and described in the Figures. It will be appreciated that methods and devices in accordance with other example embodiments can include additional procedures or features different than those shown in the Figures. Example embodiments are described herein with respect to tailgate gap covers and floating marine deck covers. However, it will be understood that these examples are for the purpose of illustrating the principles, and that the invention is not so limited. Additionally, methods and devices in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

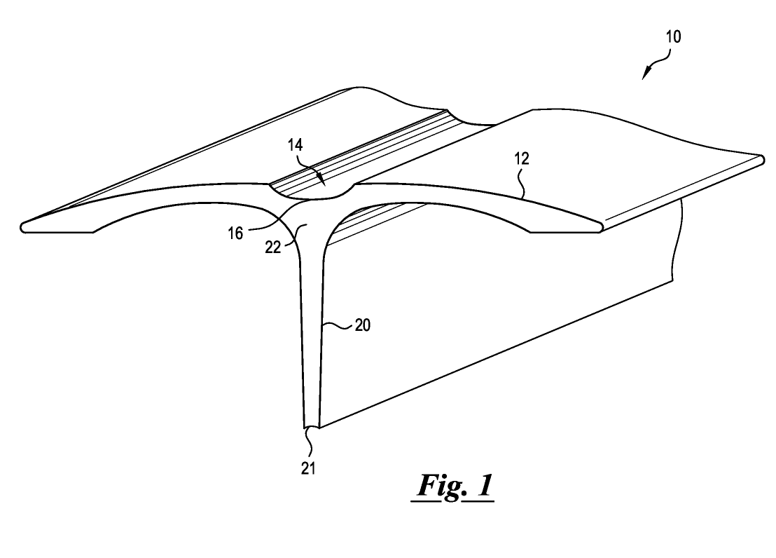

Referring now to FIG. 1, an isometric view of an example of a tailgate gap cover is schematically shown. A tailgate gap cover 10 for covering a gap between two adjacent surfaces includes an elongated top member 12 where the top member 12 has a generally arcuate T-shaped cross-sectional profile. An elongated concave relief central portion 14 extends lengthwise along the center 16 of the top member 12. An elongated insertion panel 20 extends from a central bottom portion 22 of the top member 12. The elongated insertion panel 20 extends downwardly substantially perpendicular from the top member 12.

In one useful embodiment the elongated insertion panel 20 has a cross-sectional profile that tapers downwardly from the top member 12 to the bottom end of the panel 21. In some example embodiments the elements comprise a material selected from the group consisting of ethylene propylene diene monomer (EPDM), polymers, elastomer materials, rubber, EPDM rubber and equivalents and combinations thereof. The top surface 20 may advantageously be sized to cover a gap between a tailgate and a truck bed or the like.

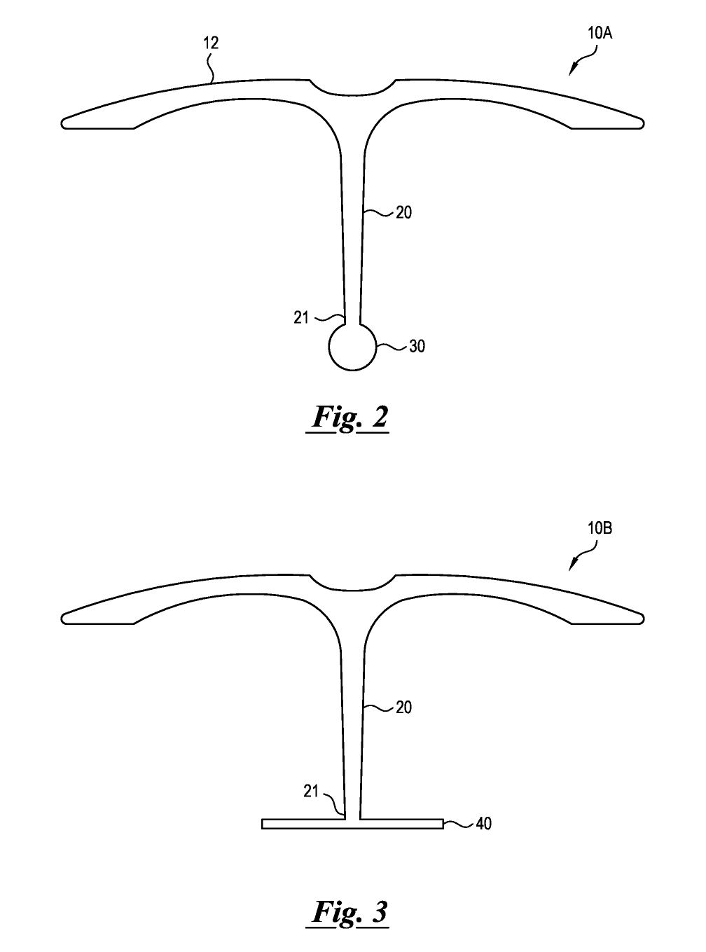

Referring now to FIG. 2, a cross-sectional view of an alternate example of a tailgate gap cover is schematically shown. Here a tailgate gap cover 10A is constructed substantially as described above with the addition of a ball member 30 integrally attached to the bottom end 21 of the elongated insertion panel 20.

Referring now to FIG. 3, a cross-sectional view of another alternate example of a tailgate gap cover is schematically shown. The tailgate gap cover 10B is constructed substantially as described above. In a departure from the above-described embodiments, the elongated insertion panel includes stand end 40, where the stand end extends in two opposing directions substantially perpendicular from the bottom end 21 of the elongated insertion panel 20.

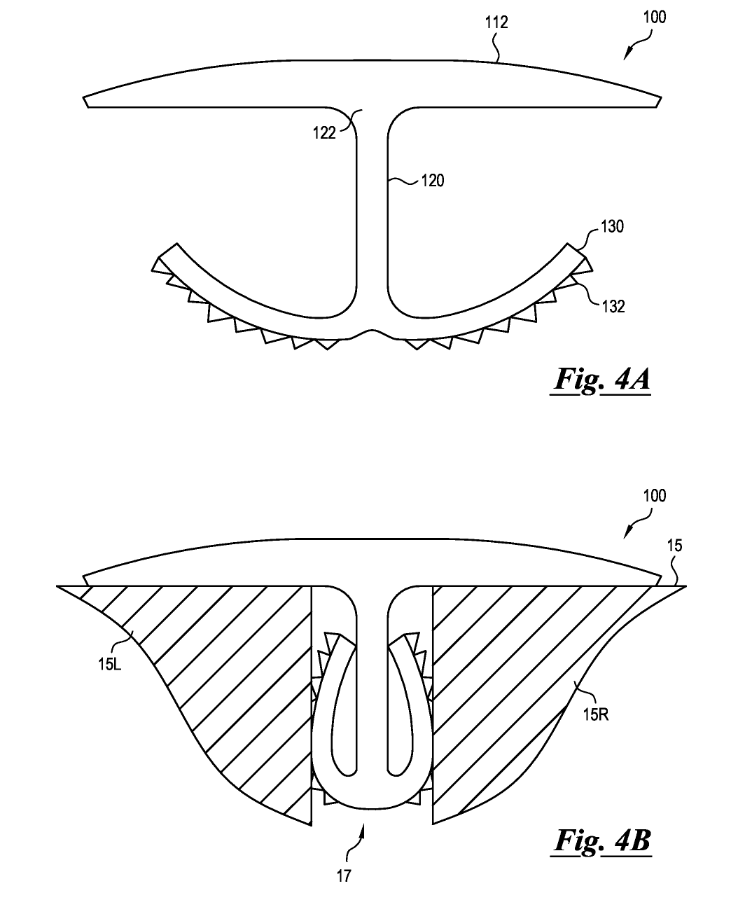

Referring now to FIG. 4A, a cross-sectional view of yet another alternate example of a tailgate gap cover is schematically shown. A flexible gap cover 100 for covering a gap between two adjacent surfaces includes an elongated top member 112 where the top member 112 has a generally arcuate T-shaped cross-sectional profile. An elongated insertion panel 120 extends from a central bottom portion 122 of the top member 112. The elongated insertion panel 120 extends downwardly substantially perpendicular from the top member 112. An elongated concave relief central portion may optionally be incorporated into the top member 112. A pair of anchor legs 130 is integrally attached to the bottom end of the elongated insertion panel 120. The anchor legs 130 may advantageously be symmetrical and have a generally upwardly curving arcuate shape, although other shapes may be used. An optional set of barbs 132 may be added to an external surface of the anchor legs for improved stability of the cover when installed.

Referring now to FIG. 4B, a cross-sectional view of the third alternate example of a tailgate gap cover in use as a marine deck gap cover is schematically shown. In this example, the top surface 112 is sized to cover a gap 17 between two decking members 15L, 15R of a marine deck 15. The anchor legs 130 are folded to bear against the sides of the decking members, thereby holding the gap cover securely in place.

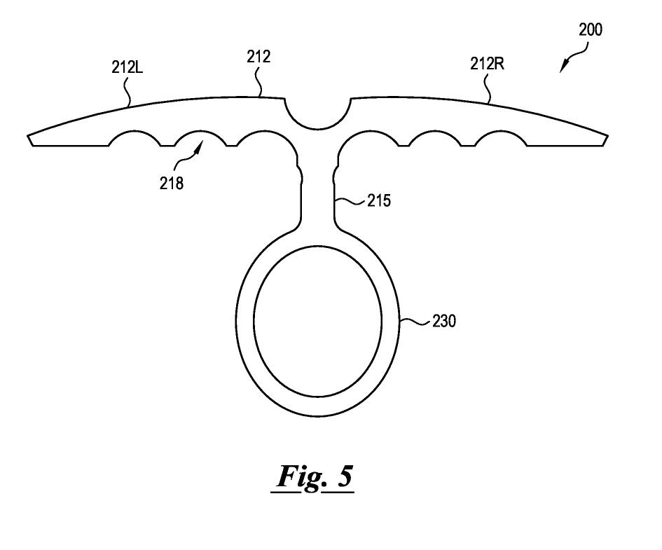

Referring now to FIG. 5, a cross-sectional view of yet another alternate example of a tailgate gap cover is schematically shown. A tailgate gap cover 200 includes a top member 212 having a relief channel 214 and left and right wing members 212L, 212R. The left and right wing members 212L, 212R have a plurality of relief channels 218 extending along an underside of each of the left and right wing members 212L, 212R, where the plurality of relief channels 218 provide added flexibility. The tailgate gap cover 200 further includes a tube member 230 attached by a stem 215 to top member 212. In use the tube member 230 operates to stabilize and secure the tailgate gap cover.

Having described the apparatus of several embodiments, it is now considered useful to the understanding of the invention to describe methods of construction and utilization of a flexible gap cover as contemplated by this disclosure. In one useful embodiment a flexible, T-shaped cover may comprise one continuous piece that requires no assembly and has no moving parts. One useful process for manufacturing the cover product is by extrusion using a polymer type material such as EPDM. The flexible cover may advantageously be extruded according to known material extrusion method and be cut to a desired length.

As described above, the top portion of the “T” is curved and tapered at each edge. The vertical portion of the “T” may advantageously be downwardly tapered from top to bottom with the top being wider and then tapering to a narrow bottom. A typical length for use in a truck bed would be approximately 60″. A typical width for this same use would be approximately 4.5″. An alternative version of this invention would include bottom barbs or grips on the lower section wide enough to catch both sides of the extremely wide gap such as on a floating marina dock. This would also be produced by the extrusion method and could possibly be made with some recycled rubber.

As described above, one important use of the tailgate cover product disclosed herein is for spanning and covering the gap of a truck bed and adjoining tailgate. Other applications are also contemplated such as, for example, use in the gap between stairs and a porch as in a manufactured home where the building code does not allow the deck or stairs to be attached to the home structure. In another application the flexible cover may be installed in a marina between floating dock sections or in the gap between the ramp from a solid dock to a floating dock.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

What is claimed is:

1. A tailgate gap cover for covering a gap between two adjacent surfaces comprising:
an elongated top member where the top member has a generally arcuate T-shaped cross-sectional profile wherein the top member includes left and right wing members, the left and right wing members each having a plurality of relief channels extending along an underside of each of the left and right wing members, where the plurality of relief channels provide added flexibility;
an elongated concave relief central portion that extends lengthwise along the center of the top member; and
an elongated insertion panel affixed to a central bottom portion of the top member, where the elongated insertion panel extends downwardly substantially perpendicular from the top member.

2. The tailgate gap cover of claim 1 wherein the elongated insertion panel includes a ball end as viewed in cross-section.

3. The tailgate gap cover of claim 1 wherein the elongated insertion panel tapers downwardly from the top member.

4. The tailgate gap cover of claim 1 wherein the elements comprise a material selected from the group consisting of ethylene propylene diene monomer (EPDM), polymers, elastomers, rubber, EPDM rubber and combinations thereof.

5. The tailgate gap cover of claim 1 wherein the top surface is sized to cover a gap between a tailgate and a truck bed.
